(19) United States
(12) Patent Application Publication
(10) Pub. No.: US 2018/0026833 A1
(43) Pub. Date: Jan. 25, 2018

(54) ALARM PROCESSING METHODS AND DEVICES

(71) Applicant: ZTE Corporation, Shenzhen (CN)

(72) Inventors: Weihong ZHU, Shenzhen (CN); Weijin XIAO, Shenzhen (CN)

(21) Appl. No.: 15/543,930

(22) PCT Filed: Jul. 27, 2015
(86) PCT No.: PCT/CN2015/085229

§ 371 Date: Jul. 14, 2017

(30) Foreign Application Priority Data
Jan. 16, 2015 (CN) 201510024214.7

(51) Int. Cl. H04L 12/24

(52) U.S. Cl. CPC H04L 41/0686; H04L 41/044

(57) ABSTRACT

Alarm processing methods and devices are provided. According to an alarm processing method, it is detected that a Network Functions Virtualization Infrastructure (NFVI) layer has a virtual resource pool failure; it is determined that the virtual resource pool failure is correlated to a Virtualized Network Function (VNF) instance; an NFVI layer alarm, which includes identification information identifying that an alarm type of the NFVI layer alarm is a virtual resource pool alarm, is generated; and the generated NFVI layer alarm is sent to a Virtualized Infrastructure Manager entity (VIM), and the identification information is used for indicating the VIM to send the NFVI layer alarm, the alarm type of which is the virtual resource pool alarm, to an Element Management System (EMS) through a Virtualized Network Function Manager entity (VNFM).

### TECHNICAL FIELD

The disclosure relates to the field of communications, and more particularly, to an alarm processing methods and devices.

### BACKGROUND

In a field of management of a wireless communication system, an interface between a Network Management System (NMS) and an Element Management System (EMS) may be called as a northbound interface (Iff-N). The EMS mainly implements an Element Management Layer (EML) function in International Telecommunication Union (ITU) Telecommunications Management Network (TMN), that is, implements a management function for one or more mobile communication equipment. Generally, different equipment suppliers cannot share the same EMS. The NMS mainly implements a Network Management Layer (NML) function in the ITU TMN, and is responsible for the management of all network elements in a managed network. When there are multiple equipment suppliers in the managed network (also referred to as a sub-network), the management of the entire sub-network may be achieved by means of the management via respective EMSs of the multiple equipment suppliers.

Currently, in order to improve the flexibility of a communication network and reduce the management cost, a Network Functions Virtualization (NFV) concept is put forward by operators. When the NFV technology is used, original physical network element equipment is replaced by a Virtualized Network Function (VNF), so that the network function is decoupled from specific hardware. FIG. 1 is a diagram showing the architecture of network functions virtualization. As shown in FIG. 1, the architecture involves structures including: NFV management and orchestration; an orchestrator; a service, VNF and infrastructure description; a VMF manager; a virtualized infrastructure manager; virtual computing; virtual storage; a virtual network; a virtualization layer; computing hardware; storage hardware; network hardware; execution reference points; other reference points; and main NFV reference points. The VNF is isolated from a Network Functions Virtualization Infrastructure (NFVI) of a bottom layer. Under such a circumstance, the NFVI of the bottom layer is a brand-new portion relative to original network architecture and therefore cannot be managed by the EMS at present. However, as the VNF is operated on a virtual machine provided by the NFVI, when a related resource in the NFVI has a failure, such failure is possible to have an impact on a VNF instance currently being executed. To repair an NFVI layer failure (for example, a virtual resource pool failure) having the impact on the VNF instance as soon as possible, the EMS may need to known the situation of the failure, namely to receive alarm information of the related failure. However, no method which can receive and explicitly identify an alarm correlated to a VNF instance generated due to the virtual resource pool failure of the NFVI layer has been presented.

Therefore, there exists a problem that the EMS cannot identify the alarm correlated to a VNF instance and generated due to the virtual resource pool failure of the NFVI layer.

### SUMMARY

Some embodiments of the disclosure provide an alarm processing methods and devices, which may at least solve the problem that the EMS cannot identify the alarm correlated to a VNF instance and generated due to the virtual resource pool failure of the NFVI layer.

According to an embodiment of the disclosure, an alarm processing method is provided, which includes the following acts. It is detected that an NFVI layer has a virtual resource pool failure. It is determined that the virtual resource pool failure is correlated to a VNF instance. An NFVI layer alarm, which includes identification information identifying that an alarm type of the NFVI layer alarm is a virtual resource pool alarm, is generated. The generated NFVI layer alarm is sent to a VIM, and the identification information is used for indicating the VIM to send the NFVI layer alarm, the alarm type of which is the virtual resource pool alarm, to an EMS through a VNFM.

In an exemplary embodiment, the virtual resource pool alarm may include at least one of: a hypervisor (also referred to as virtual machine monitor) alarm, a virtual resource alarm or a physical resource alarm.

According to another embodiment of the disclosure, an alarm processing method is provided, which includes the following acts. An NFVI layer alarm reported by an NFVI layer is received. It is determined, according to the NFVI layer alarm, that the NFVI layer alarm is correlated to a VNF instance. Identification information identifying that an alarm type of the NFVI layer alarm is a virtual resource pool alarm is added in the received NFVI layer alarm. The NFVI layer alarm added with the identification information is sent to a VNFM, and the identification information is used for indicating the VNFM to send the NFVI layer alarm, added with the identification information, to an EMS.

In an exemplary embodiment, the virtual resource pool alarm may include at least one of: a hypervisor (also referred to as virtual machine monitor) alarm, a virtual resource alarm or a physical resource alarm.

According to another embodiment of the disclosure, an alarm processing method is provided, which includes the following acts. An NFVI layer alarm reported by a VIM is received, and the NFVI layer alarm may include identification information identifying that an alarm type of the NFVI layer alarm is a virtual resource pool alarm. The NFVI layer alarm is sent to an EMS, and the identification information is used for indicating the EMS to send the NFVI layer alarm, added with the identification information, to a Network Management System (NMS).

In an exemplary embodiment, the virtual resource pool alarm may include at least one of: a hypervisor (also referred to as virtual machine monitor) alarm, a virtual resource alarm or a physical resource alarm.

According to still another embodiment of the disclosure, an alarm processing method is provided, which includes the following acts. An NFVI layer alarm reported by a VNFM is received, and the NFVI layer alarm may include identification information identifying that an alarm type of the NFVI layer alarm is a virtual resource pool alarm. The received NFVI layer alarm is sent to an NMS.

In an exemplary embodiment, the virtual resource pool alarm may include at least one of: a hypervisor (also referred to as virtual machine monitor) alarm, a virtual resource alarm or a physical resource alarm.

According to one embodiment of the disclosure, an alarm processing device is provided, which includes a detecting module, a first determining module, a generating module and a first sending module. The detecting module is configured to detect that an NFVI layer has a virtual resource pool failure. The first determining module is configured to determine that the virtual resource pool failure is correlated to a VNF instance. The generating module is configured to generate an NFVI layer alarm, and the NFVI layer alarm may include identification information identifying that an alarm type of the NFVI layer alarm is a virtual resource pool alarm. The first sending module is configured to send the generated NFVI layer alarm to a VIM, and the identification information is used for indicating the VIM to send the NFVI layer alarm, the alarm type of which is the virtual resource pool alarm, to an EMS through a VNFM.

According to another embodiment of the disclosure, an NFVI entity is provided, including the above-mentioned device.

According to one embodiment of the disclosure, an alarm processing device is provided, which includes a first receiving module, a second determining module, an adding module and a second sending module. The first receiving module is configured to receive an NFVI layer alarm reported by an NFVI layer. The second determining module is configured to determine, according to the NFVI layer alarm, that the NFVI layer alarm is correlated to a VNF instance. The adding module is configured to add identification information identifying that an alarm type of the NFVI layer alarm is a virtual resource pool alarm in the received NFVI layer alarm. The second sending module is configured to send the NFVI layer alarm added with the identification information to a VNFM, and the identification information is used for indicating the VNFM to send the NFVI layer alarm, added with the identification information, to an EMS.

According to another embodiment of the disclosure, a VIM is provided, including the above-mentioned device.

According to one embodiment of the disclosure, an alarm processing device is provided, which includes a second receiving module and a third sending module. The second receiving module is configured to receive an NFVI layer alarm reported by a VIM, and the NFVI layer alarm may include identification information identifying that an alarm type of the NFVI layer alarm is a virtual resource pool alarm. The third sending module is configured to send the NFVI layer alarm to an EMS, and the identification information is used for indicating the EMS to send the NFVI layer alarm, added with the identification information, to an NMS.

According to another embodiment of the disclosure, a VNFM is provided, including the above-mentioned device.

According to one embodiment of the disclosure, an alarm processing device is provided, which includes a third receiving module and a fourth sending module. The third receiving module is configured to receive an NFVI layer alarm reported by a VNFM, and the NFVI layer alarm may include identification information identifying that an alarm type of the NFVI layer alarm is a virtual resource pool alarm. The fourth sending module is configured to send the received NFVI layer alarm to an NMS.

According to another embodiment of the disclosure, an EMS is provided, including the above-mentioned device.

According to the solution provided by some embodiments of the present disclosure, it is detected that a NFVI layer has a virtual resource pool failure, it is determined that the virtual resource pool failure is correlated to a VNF instance, a NFVI layer alarm which includes identification information identifying that an alarm type of the NFVI layer alarm is a virtual resource pool alarm is generated and sent to a VIM, and the identification information is used for indicating the VIM to send the NFVI layer alarm, the alarm type of which is the virtual resource pool alarm, to the EMS through the VNFM. By virtue of the solution of some embodiments, the problem that the EMS cannot identify the alarm correlated to a VNF instance and generated due to the virtual resource pool failure of the NFVI layer is solved. The effect that the EMS can explicitly identify the alarm correlated to a VNF instance and generated due to the virtual resource pool failure of the NFVI layer is achieved.

### BRIEF DESCRIPTION OF THE DRAWINGS

FIG. 1 is a diagram showing the architecture of network functions virtualization;

FIG. 2 is a flowchart of an alarm processing method according to a first embodiment of the disclosure;

FIG. 3 is a flowchart of an alarm processing method according to a second embodiment of the disclosure;

FIG. 4 is a flowchart of an alarm processing method according to a third embodiment of the disclosure;

FIG. 5 is a flowchart of an alarm processing method according to a fourth embodiment of the disclosure;

FIG. 6 is a structure diagram of an alarm processing device according to a first embodiment of the disclosure;

FIG. 7 is a structure diagram of an NFVI entity according to an embodiment of the disclosure;

FIG. 8 is a structure diagram of an alarm processing device according to a second embodiment of the disclosure;

FIG. 9 is a structure diagram of a VIM according to an embodiment of the disclosure;

FIG. 10 is a structure diagram of an alarm processing device according to a third embodiment of the disclosure;

FIG. 11 is a structure diagram of a VNFM according to an embodiment of the disclosure;

FIG. 12 is a structure diagram of an alarm processing device according to a fourth embodiment of the disclosure;

FIG. 13 is a structure diagram of an EMS entity according to an embodiment of the disclosure;

FIG. 14 is a flowchart of a virtual network resource alarm reporting method according to an embodiment of the disclosure.

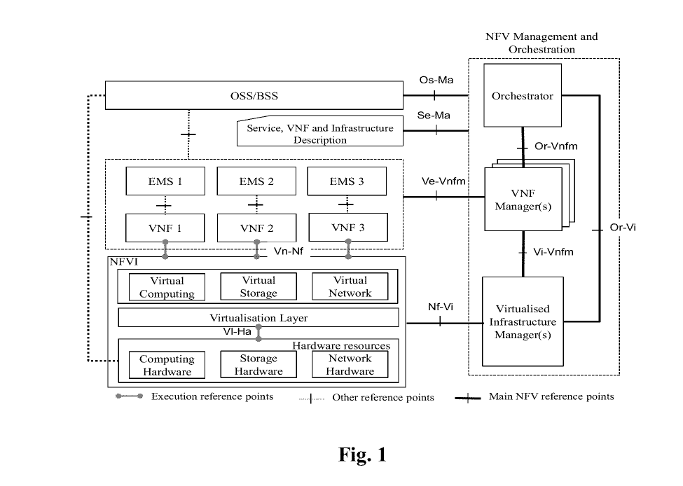

### DETAILED DESCRIPTION OF THE EMBODIMENTS

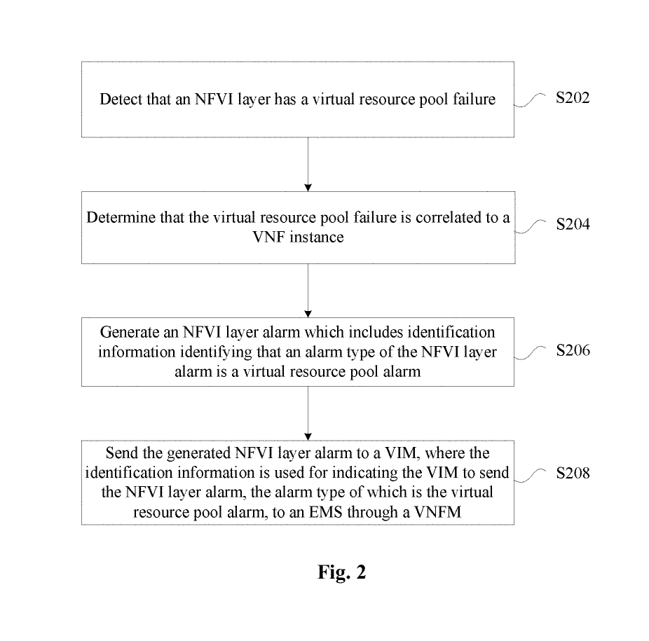

An alarm processing method is provided in an embodiment. FIG. 2 is a flowchart of an alarm processing method according to a first embodiment of the disclosure. As shown in FIG. 2, the alarm processing method includes the following acts.

At act S202, it is detected that an NFVI layer has a virtual resource pool failure.

At act S204, it is determined that the virtual resource pool failure is correlated to a VNF instance.

At act S206, an NFVI layer alarm, which includes identification information identifying that an alarm type of the NFVI layer alarm is a virtual resource pool alarm, is generated.

At act S208, the generated NFVI layer alarm is sent to a VIM. The identification information is used for indicating the VIM to send the NFVI layer alarm, the alarm type of which is the virtual resource pool alarm, to an EMS through a VNFM.

By means of the above acts, after determining that the virtual resource pool failure is correlated to the VNF instance, it may be determined that the virtual resource pool failure of the NFVI layer has an impact on a VNF instance currently being executed. The generated alarm includes the identification information identifying that the alarm type of the alarm is the virtual resource pool alarm, so that the EMS which receives the alarm can identify that a reason for the VNF alarm is the virtual resource pool failure, in other words, the alarm type is the virtual resource pool alarm. The problem that the EMS cannot identify the alarm correlated to a VNF instance and generated due to the virtual resource pool failure of the NFVI layer is solved. The effect that the EMS can explicitly identify the alarm correlated to a VNF instance and generated due to the virtual resource pool failure of the NFVI layer is achieved.

In an exemplary embodiment, the virtual resource pool alarm may include at least one of: a hypervisor (also referred to as virtual machine monitor) alarm, a virtual resource alarm or a physical resource alarm.

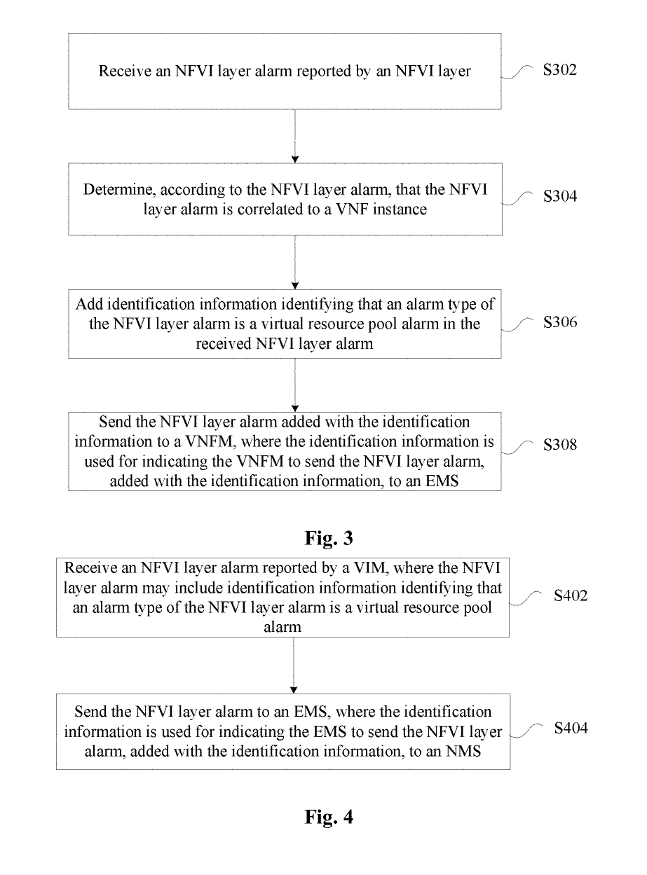

FIG. 3 is a flowchart of an alarm processing method according to a second embodiment of the disclosure. As shown in FIG. 3, the alarm processing method includes the following acts.

At act S302, an NFVI layer alarm reported by an NFVI layer is received.

At act S304, it is determined, according to the NFVI layer alarm, that the NFVI layer alarm is correlated to a VNF instance.

At act 306, identification information identifying that an alarm type of the NFVI layer alarm is a virtual resource pool alarm is added in the received NFVI layer alarm.

At act S308, the NFVI layer alarm added with the identification information is sent to a VNFM. The identification information is used for indicating the VNFM to send the NFVI layer alarm, added with the identification information, to an EMS.

By means of the above acts, after determining that the virtual resource pool failure is correlated to the VNF instance, the identification information identifying that the alarm type of the alarm is the virtual resource pool alarm may be added in the received alarm, so that the EMS which receives the alarm can identify that a reason for the VNF alarm is the virtual resource pool failure, in other words, the alarm type is the virtual resource pool alarm. The problem that the EMS cannot identify the alarm correlated to a VNF instance and generated due to the virtual resource pool failure of the NFVI layer is solved. The effect that the EMS can explicitly identify the alarm correlated to a VNF instance and generated due to the virtual resource pool failure of the NFVI layer is achieved.

In an exemplary embodiment, the virtual resource pool alarm may include at least one of: a hypervisor (also referred to as virtual machine monitor) alarm, a virtual resource alarm or a physical resource alarm.

FIG. 4 is a flowchart of an alarm processing method according to a third embodiment of the disclosure. As shown in FIG. 4, the alarm processing method includes the following acts.

At act S402, an NFVI layer alarm reported by a VIM is received. The NFVI layer alarm may include identification information identifying that an alarm type of the NFVI layer alarm is a virtual resource pool alarm.

At act S404, the NFVI layer alarm is sent to an EMS. The identification information is used for indicating the EMS to send the NFVI layer alarm, added with the identification information, to an NMS.

By means of the above acts, after receiving the alarm which is reported by the VIM and carries the identification information identifying that the alarm type is the virtual resource pool alarm, the alarm may be sent to the EMS, so that the EMS which receives the alarm can identify that a reason for the VNF alarm is the virtual resource pool failure, in other words, the alarm type is the virtual resource pool alarm. The problem that the EMS cannot identify the alarm correlated to a VNF instance and generated due to the virtual resource pool failure of the NFVI layer is solved. The effect that the EMS can explicitly identify the alarm correlated to a VNF instance and generated due to the virtual resource pool failure of the NFVI layer is achieved.

In an exemplary embodiment, the virtual resource pool alarm may include at least one of: a hypervisor (also referred to as virtual machine monitor) alarm, a virtual resource alarm or a physical resource alarm.

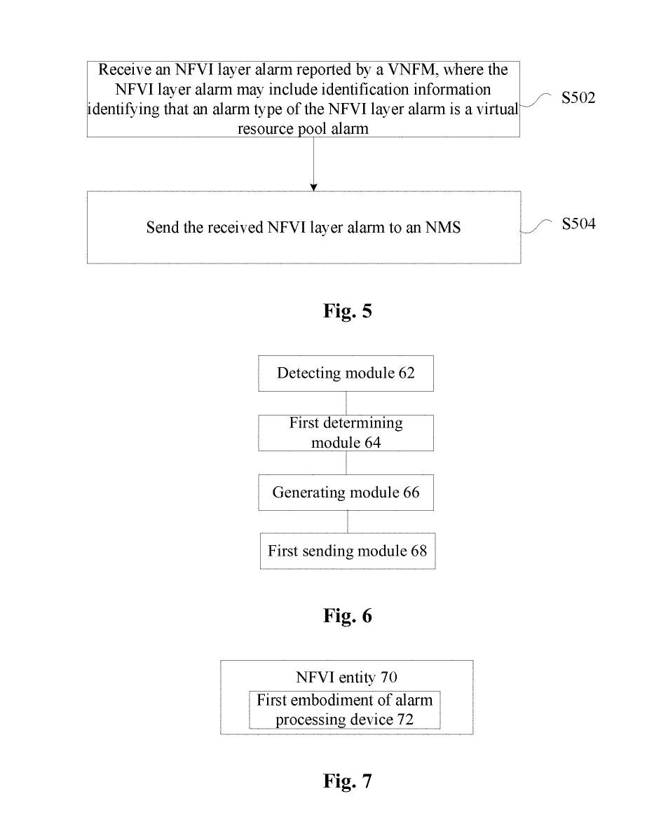

FIG. 5 is a flowchart of an alarm processing method according to a fourth embodiment of the disclosure. As shown in FIG. 5, the alarm processing method includes the following acts.

At act S502, an NFVI layer alarm reported by a VNFM is received. The NFVI layer alarm may include identification information identifying that an alarm type of the NFVI layer alarm is a virtual resource pool alarm.

At act S504, the received NFVI layer alarm is sent to an NMS.

By means of the above acts, after receiving the alarm which is reported by the VNFM and carries the identification information identifying that the alarm type is the virtual resource pool alarm, it may be determined that the alarm is sent due to a virtual resource pool failure, and the alarm may be sent to the NMS, so that the NMS which receives the alarm can identify that a reason for the VNF alarm is the virtual resource pool failure, in other words, the alarm type is the virtual resource pool alarm. The problem that the EMS cannot identify the alarm correlated to a VNF instance and generated due to the virtual resource pool failure of the NFVI layer is solved. The effect that the EMS can explicitly identify the alarm correlated to a VNF instance and generated due to the virtual resource pool failure of the NFVI layer is achieved.

In an exemplary embodiment, the virtual resource pool alarm may include at least one of: a hypervisor (also referred to as virtual machine monitor) alarm, a virtual resource alarm or a physical resource alarm.

Some alarm processing devices are provided in the embodiments. The devices are configured to implement the above-mentioned embodiments and the exemplary implementation. With regard to the part that has been described, no further description is provided. As used in the followings, terms “module” can achieve a combination of software and/or hardware with predetermined functions. Although the device described by the following embodiments may be preferably implemented by the software, the device may also be contemplated to be implemented by the hardware or the combination of the software and the hardware.

FIG. 6 is a structure diagram of an alarm processing device according to a first embodiment of the disclosure. As shown in FIG. 6, the device includes a detecting module 62, a first determining module 64, a generating module 66 and a first sending module 68. The device will be described below.

The detecting module 62 is configured to detect that an NFVI layer has a virtual resource pool failure. The first determining module 64 is coupled to the detecting module 62, and is configured to determine that the virtual resource pool failure is correlated to a VNF instance. The generating module 66 is coupled to the first determining module 64 and is configured to generate an NFVI layer alarm, and the NFVI layer alarm may include identification information identifying that an alarm type of the NFVI layer alarm is a virtual resource pool alarm. The first sending module 68 is coupled to the generating module 66 and is configured to send the generated NFVI layer alarm to a VIM, and the identification information is used for indicating the VIM to send the NFVI layer alarm, the alarm type of which is the virtual resource pool alarm, to an EMS through a VNFM.

FIG. 7 is a structure diagram of an NFVI entity according to an embodiment of the disclosure. As shown in FIG. 7, the VNFM 70 includes the first embodiment of alarm processing device 72 mentioned above.

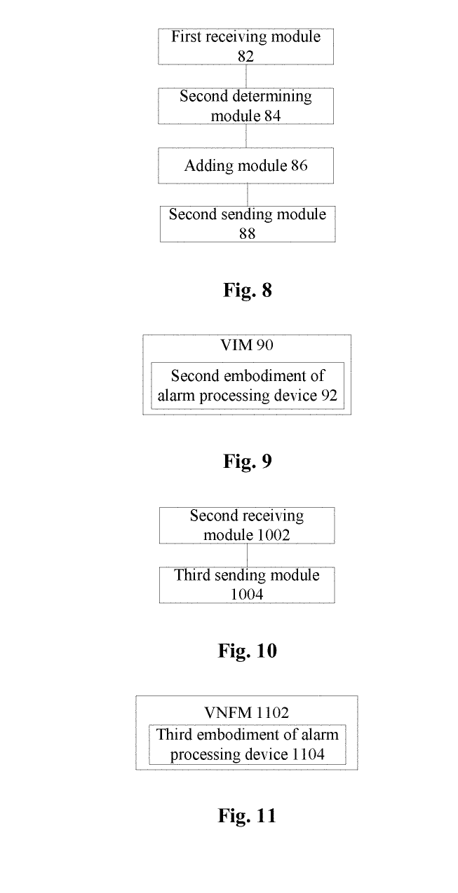

FIG. 8 is a structure diagram of an alarm processing device according to a second embodiment of the disclosure. As shown in FIG. 8, the device includes a first receiving module 82, a second determining module 84, an adding module 86 and a second sending module 88. The device will be described below.

The first receiving module 82 is configured to receive an NFVI layer alarm reported by an NFVI layer. The second determining module 84 is coupled to the first receiving module 82 and is configured to determine, according to the NFVI layer alarm, that the NFVI layer alarm is correlated to a VNF instance. The adding module 86 is coupled to the second determining module 84 and is configured to add identification information identifying that an alarm type of the NFVI layer alarm is a virtual resource pool alarm in the received NFVI layer alarm. The second sending module 88 is coupled to the adding module 86 and is configured to send the NFVI layer alarm added with the identification information to a VNFM, and the identification information is used for indicating the VNFM to send the NFVI layer alarm, added with the identification information, to an EMS.

FIG. 9 is a structure diagram of a VIM according to an embodiment of the disclosure. As shown in FIG. 9, the VIM 90 includes the second embodiment of alarm processing device 92 mentioned above.

FIG. 10 is a structure diagram of an alarm processing device according to a third embodiment of the disclosure. As shown in FIG. 10, the device includes a second receiving module 1002 and a third sending module 1004. The device will be described below.

The second receiving module 1002 is configured to receive an NFVI layer alarm reported by a VIM, and the NFVI layer alarm may include identification information identifying that an alarm type of the NFVI layer alarm is a virtual resource pool alarm. The third sending module 1004 is coupled to the second receiving module 1002 and is configured to send the NFVI layer alarm to an EMS, and the identification information is used for indicating the EMS to send the NFVI layer alarm, added with the identification information, to an NMS.

FIG. 11 is a structure diagram of a VNFM according to an embodiment of the disclosure. As shown in FIG. 11, the VNFM 1102 includes the third embodiment of alarm processing device 1104 mentioned above.

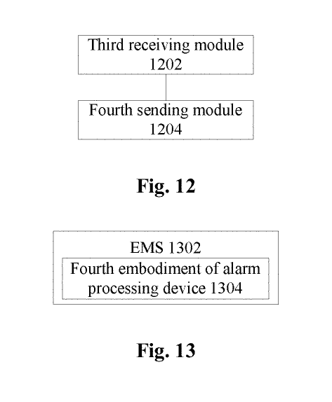

FIG. 12 is a structure diagram of an alarm processing device according to a fourth embodiment of the disclosure. As shown in FIG. 12, the device includes a third receiving module 1202 and a fourth sending module 1204. The device will be described below.

The third receiving module 1202 is configured to receive an NFVI layer alarm reported by a VNFM, and the NFVI layer alarm may include identification information identifying that an alarm type of the NFVI layer alarm is a virtual resource pool alarm. The fourth sending module 1204 is coupled to the third receiving module 1202 and is configured to send the received NFVI layer alarm to an NMS.

FIG. 13 is a structure diagram of an EMS entity according to an embodiment of the disclosure. As shown in FIG. 13, the EMS 1302 includes the fourth embodiment of alarm processing device 1304 mentioned above.

In the related technology, no method which can enable the EMS to receive and explicitly identify the alarm correlated to a VNF instance and generated due to the virtual resource pool failure of the NFVI layer is provided. A virtual network resource alarm reporting method is provided in the embodiments. By means of increasing a new alarm type and filling out the new alarm type when reporting the alarm, the EMS can receive and explicitly identify the alarm correlated to a VNF instance and generated due to the virtual resource pool failure of the NFVI layer.

The virtual network resource alarm reporting method may generally include the following acts. When an NFVI layer has a virtual resource pool failure, a related alarm is generated and reported to a VIM. The VIM performs analysis on the related alarm and determines whether the alarm is correlated to a VNF instance; if the alarm is not an alarm correlated to a VNF instance, the VIM reports the alarm to a Network Functions Virtualization Orchestrator (NFVO) and the process ends; if the alarm is the alarm correlated to a VNF instance, the VIM reports the alarm to a VNFM. The VNFM sets an alarm type in alarm information to be a virtual resource pool alarm and sends the alarm to an EMS. The VNFM may also perform correlation analysis on the alarm first and then sends the alarm information after the correlation analysis, and alarm type information set to be a virtual resource pool alarm is suggested be included. After receiving the alarm information, the EMS forwards the information to an NMS, and the alarm information includes the alarm type information which is set to be the virtual resource pool alarm.

It should be noted that there is a possibility that all of the VNFM, the EMS, the NFVO and the NMS may perform corresponding alarm association analysis after receiving the alarm information in the above alarm reporting process. The virtual resource pool alarm may be divided into a hypervisor (also referred to as virtual machine monitor) alarm, a virtual resource alarm or a physical resource alarm.

According to the above method, by means of increasing the new alarm type and filling out the new alarm type when reporting the alarm, the EMS can receive and explicitly identify the alarm correlated to a VNF instance and generated due to the virtual resource pool failure of the NFVI layer.

The disclosure is described below with reference to exemplary embodiments.

### First Exemplary Embodiment

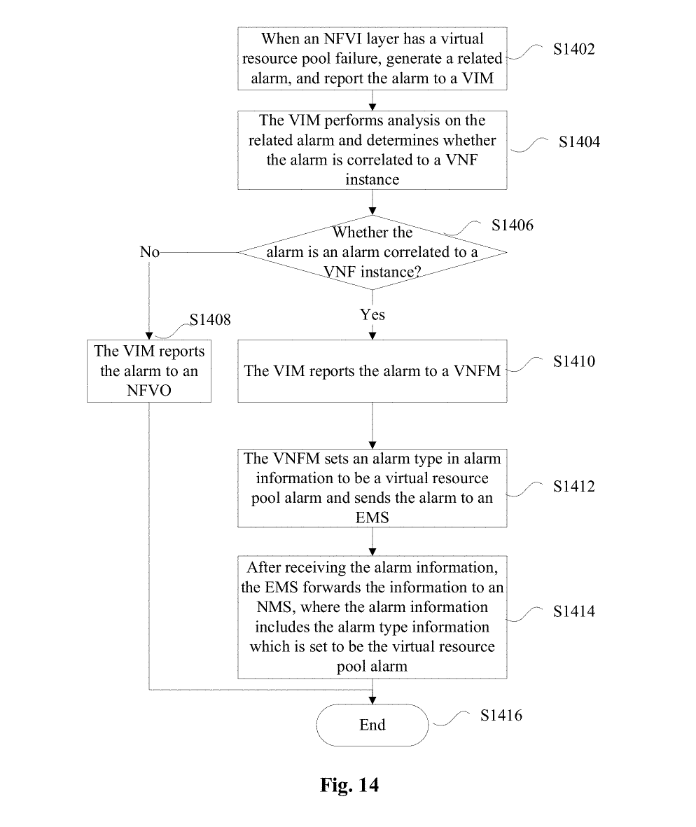

FIG. 14 is a flowchart of a virtual network resource alarm reporting method according to an embodiment of the disclosure. As shown in FIG. 14, the method may include the following acts.

At act S1402, when an NFVI layer has a virtual resource pool failure, a related alarm is generated and reported to a VIM.

At act S1404, the VIM performs analysis on the related alarm and determines whether the alarm is correlated to a VNF instance.

At act S1406, it is judged whether the related alarm is an alarm correlated to a VNF instance, if the related alarm is not an alarm correlated to a VNF instance, act S1408 is executed; or otherwise the act S1410 is executed.

At act S1408, if the alarm is not the alarm correlated to a VNF instance, the VIM reports the alarm to an NFVO, the process ends and act S1416 is executed.

At act S1410, if the alarm is the alarm correlated to a VNF instance, the VIM reports the alarm to a VNFM.

At act S1412, the VNFM sets an alarm type in alarm information to be a virtual resource pool alarm and sends the alarm to the EMS.

At act S1414, after receiving the alarm information, the EMS forwards the information to an NMS, and the alarm information includes alarm type information which is set to be the virtual resource pool alarm.

At act S1416, the flow of the virtual network resource alarm reporting method ends.

### Second Exemplary Embodiment

A virtual network resource alarm reporting method is provided in the exemplary embodiment, which includes the following acts.

At act S1, when an NFVI layer generates a virtual resource pool failure (a hypervisor failure, a virtual resource failure (such as virtual CPU, virtual storage and virtual network) or a physical resource failure), a related alarm is generated and reported to a VIM. The alarm information may include alarm type information, used for indicating a failure type (such as hypervisor failure, virtual resource failure or physical resource failure) causing the alarm.

At act S2, the VIM performs analysis on the related alarm and determines whether the alarm is correlated to a VNF instance.

At act S3, if the alarm is not the alarm correlated to a VNF instance, the VIM reports the alarm to an NFVO, and the process ends; and if the alarm is the alarm correlated to a VNF instance, the VIM reports the alarm to a VNFM and act S4 is executed.

At act S4, according to the alarm type information in the received alarm information, the VNFM prepares the alarm information to be sent to an EMS. The alarm type in the alarm information may be set to be one of a hypervisor (also referred to as virtual machine monitor) alarm, a virtual resource alarm or a physical resource alarm, and the alarm is sent to the EMS.

At act S5, after receiving the alarm information, the EMS forwards the alarm information to an NMS. The alarm information includes the alarm type information, which may be one of the hypervisor (also referred to as virtual machine monitor) alarm, the virtual resource alarm or the physical resource alarm.

At act S6, the flow of the virtual network resource alarm reporting method ends.

### Third Exemplary Embodiment

A virtual network resource alarm reporting method is provided in the exemplary embodiment, which includes the following acts.

At act S1, when an NFVI layer has a virtual resource pool failure, a related alarm is generated and reported to a VIM.

At act S2, the VIM performs analysis on the related alarm and determines whether the alarm is correlated to a VNF instance.

At act S3, if the alarm is not an alarm correlated to a VNF instance, the VIM reports the alarm to an NFVO, and the process ends; and if the alarm is the alarm correlated to a VNF instance, the VIM reports the alarm to a VNFM and act S4 is executed.

At act S4, after receiving the alarm, the VNFM first performs correlation analysis on the alarm. If the alarm needs to be sent to an EMS after the correlation analysis, the VNFM sets an alarm type in alarm information to be a virtual resource pool alarm, and sends the alarm to an EMS.

At act S5, after receiving the alarm information, the EMS first performs the correlation analysis on the alarm. If the alarm needs to be sent to an NMS after the correlation analysis, the EMS forwards the alarm information to the NMS. The alarm information may include alarm type information, which may be set to be the virtual resource pool alarm.

At act S6, the flow of the virtual network resource alarm reporting method ends.

### Fourth Exemplary Embodiment

A virtual network resource alarm reporting method is provided in the exemplary embodiment, which includes the following acts.

At act S1, when an NFVI layer has a virtual resource pool failure, a related alarm is generated and the alarm is analyzed. It is determined whether the alarm is correlated to a VNF. A label indicating whether the alarm is correlated to a VNF instance is added in alarm information according to an analysis result, and the alarm is reported to a VIM.

At act S2, after receiving the alarm, the VIM determines a subsequent action according to the label about whether the alarm is correlated to the VNF instance in the alarm information.

At act S3, if the alarm is not an alarm correlated to a VNF instance, the VIM reports the alarm to an NFVO and the process ends; and if the alarm is the alarm correlated to a VNF instance, the VIM reports the alarm to a VNFM and act S4 is executed.

At act S4, the VNFM sets an alarm type in the alarm information to be a virtual resource alarm and sends the alarm to an EMS.

At act S5, after receiving the alarm information, the EMS forwards the alarm information to an NMS. The alarm information includes alarm type information which is set to be the virtual resource alarm.

At act S6, the flow of the virtual network resource alarm reporting method ends.

Apparently, those skilled in the art shall understand that the above modules and acts of the disclosure can be realized by using a general purpose calculating device, can be integrated to one calculating device or distributed on a network which consists of a plurality of calculating devices, and alternatively they can be realized by using the executable program code of the calculating device, so that consequently they can be stored in the storing device and executed by the calculating device, in some cases, can perform the shown or described act in sequence other than herein, or they are made into integrated circuit module respectively, or a plurality of modules or acts thereof are made into one integrated circuit module. In this way, the disclosure is not restricted to any particular hardware and software combination.

The above description is only exemplary embodiments of the disclosure and is not intended to limit the disclosure, and the disclosure can have a variety of changes and modifications for those skilled in the art. Any modification, equivalent replacement, or improvement made within the principle of the disclosure shall all fall within the protection scope defined by the appended claims of the disclosure.

### INDUSTRIAL APPLICABILITY

As described above, by means of some embodiments and exemplary implementation, the problem that the EMS cannot identify the alarm correlated to a VNF instance and generated due to the virtual resource pool failure of the NFVI layer is solved. The effect that the EMS can explicitly identify the alarm correlated to a VNF instance and generated due to the virtual resource pool failure of the NFVI layer is achieved.

1.-4. (canceled)

5. An alarm processing method, comprising:
receiving a Network Functions Virtualization Infrastructure (NFVI) layer alarm reported by a Virtualized Infrastructure Manager entity (VIM), wherein the NFVI layer alarm comprises identification information identifying that an alarm type of the NFVI layer alarm is a virtual resource pool alarm; and
sending the NFVI layer alarm to an Element Management System (EMS), wherein the identification information is used for indicating the EMS to send the NFVI layer alarm comprising the identification information to a Network Management System (NMS).

6. The method as claimed in claim 5, wherein the virtual resource pool alarm comprises at least one of:
a hypervisor alarm, a virtual resource alarm or a physical resource alarm.

7. An alarm processing method, comprising:
receiving a Network Functions Virtualization Infrastructure (NFVI) layer alarm reported by a Virtualized Network Function Manager entity (VNFM), wherein the NFVI layer alarm comprises identification information identifying that an alarm type of the NFVI layer alarm is a virtual resource pool alarm; and
sending the received NFVI layer alarm to a Network Management System (NMS).

8. The method as claimed in claim 7, wherein the virtual resource pool alarm comprises at least one of:
a hypervisor alarm, a virtual resource alarm or a physical resource alarm.

9.-14. (canceled)

15. An alarm processing device, comprising:
a third receiving module, configured to receive a Network Functions Virtualization Infrastructure (NFVI) layer alarm reported by a Virtualized Network Function Manager entity (VNFM), wherein the NFVI layer alarm comprises identification information identifying that an alarm type of the NFVI layer alarm is a virtual resource pool alarm; and
a fourth sending module, configured to send the received NFVI layer alarm to a Network Management System (NMS).

16. An Element Management System (EMS), comprising the device as claimed in claim 15.

17. The method as claimed in claim 7, before receiving the NFVI layer alarm reported by the VNFM, the method further comprises:
detecting that an NFVI layer has a virtual resource pool failure;
determining that the virtual resource pool failure is correlated to a Virtualized Network Function (VNF) instance;
generating the NFVI layer alarm; and
sending the generated NFVI layer alarm to a Virtualized Infrastructure Manager entity (VIM), wherein the identification information is used for indicating the VIM to send the NFVI layer alarm, the alarm type of which is the virtual resource pool alarm, to an Element Management System (EMS) through the VNFM.

18. The method as claimed in claim 17, wherein the virtual resource pool alarm comprises at least one of:
a hypervisor alarm, a virtual resource alarm or a physical resource alarm.

19. The method as claimed in claim 7, wherein before receiving the NFVI layer alarm reported by the VNFM, the method further comprises:
receiving an NFVI layer alarm reported by an NFVI layer;
determining, according to the NFVI layer alarm, that the NFVI layer alarm is correlated to a Virtualized Network Function (VNF) instance;
adding identification information identifying that an alarm type of the NFVI layer alarm is a virtual resource pool alarm in the received NFVI layer alarm; and
sending the NFVI layer alarm added with the identification information to the VNFM, wherein the identification information is used for indicating the VNFM to send the NFVI layer alarm, added with the identification information, to an Element Management System (EMS).

20. The method as claimed in claim 19, wherein the virtual resource pool alarm comprises at least one of:
a hypervisor alarm, a virtual resource alarm or a physical resource alarm.

21. The method as claimed in claim 7, wherein sending the received NFVI layer alarm to the NMS comprises:
performing correlation analysis on the NFVI layer alarm;
if the NFVI layer alarm needs to be sent to the NMS after the correlation analysis, forwarding the NFVI layer alarm to the NMS.

22. The method as claimed in claim 8, wherein sending the received NFVI layer alarm to the NMS comprises:
performing correlation analysis on the NFVI layer alarm;
if the NFVI layer alarm needs to be sent to the NMS after the correlation analysis, forwarding the NFVI layer alarm to the NMS.

23. The method as claimed in claim 5, wherein before receiving the NFVI layer alarm reported by the VIM, the method further comprises:
detecting that an NFVI layer has a virtual resource pool failure;
determining that the virtual resource pool failure is correlated to a Virtualized Network Function (VNF) instance;
generating the NFVI layer alarm; and
sending the generated NFVI layer alarm to the VIM, wherein the identification information is used for indicating the VIM to send the NFVI layer alarm, the alarm type of which is the virtual resource pool alarm, to the EMS through a Virtualized Network Function Manager entity (VNFM).

24. The method as claimed in claim 23, wherein the virtual resource pool alarm comprises at least one of:
a hypervisor alarm, a virtual resource alarm or a physical resource alarm.

25. The method as claimed in claim 5, wherein before receiving the NFVI layer alarm reported by the VIM, the method further comprises:
receiving an NFVI layer alarm reported by an NFVI layer;
determining, according to the NFVI layer alarm, that the NFVI layer alarm is correlated to a Virtualized Network Function (VNF) instance;
adding identification information identifying that an alarm type of the NFVI layer alarm is a virtual resource pool alarm in the received NFVI layer alarm; and
sending the NFVI layer alarm added with the identification information to a Virtualized Network Function Manager entity (VNFM), wherein the identification information is used for indicating the VNFM to send the NFVI layer alarm, added with the identification information, to the EMS.

26. The method as claimed in claim 25, wherein the virtual resource pool alarm comprises at least one of:
a hypervisor alarm, a virtual resource alarm or a physical resource alarm.

27. The method as claimed in claim 5, wherein sending the NFVI layer alarm to the EMS comprises:
performing correlation analysis on the NFVI layer alarm;
if the alarm needs to be sent to the EMS after the correlation analysis, setting the alarm type to be a virtual resource pool alarm, and sending the NFVI layer alarm to the EMS.

28. The method as claimed in claim 6, wherein sending the NFVI layer alarm to the EMS comprises:
performing correlation analysis on the NFVI layer alarm;
if the alarm needs to be sent to the EMS after the correlation analysis, setting the alarm type to be a virtual resource pool alarm, and sending the NFVI layer alarm to the EMS.

29. The device as claimed in claim 15, wherein the virtual resource pool alarm comprises at least one of:
a hypervisor alarm, a virtual resource alarm or a physical resource alarm.

30. The EMS as claimed in claim 16, wherein the virtual resource pool alarm comprises at least one of:
a hypervisor alarm, a virtual resource alarm or a physical resource alarm.
